(19) United States
(12) Patent Application Publication
(10) Pub. No.: US 2014/0197576 A1
(43) Pub. Date: Jul. 17, 2014

(54) DEVICE AND METHOD FOR THE PRODUCTION OF A THREE-DIMENSIONAL OBJECT

(71) Applicant: ARBURG GMBH + CO. KG, Lossburg (DE)

(72) Inventors: Herbert KRAIBUHLER, Lossburg (DE); Eberhardt DUFFNER, Starzach (DE)

(73) Assignee: ARBURG GMBH + CO. KG, Lossburg (DE)

(21) Appl. No.: 14/107,438

(22) Filed: Dec. 16, 2013

Related U.S. Application Data
(63) Continuation-in-part of application No. PCT/EP2012/002513, filed on Jun. 14, 2012.

(30) Foreign Application Priority Data
Jun. 16, 2011 (DE) 10 2011 106 614.8

(51) Int. Cl. B29C 67/00

(52) U.S. Cl. CPC B29C 67/0059; B29C 67/0092
USPC 264/308; 425/375

(57) ABSTRACT

The device and the method serve for the production of a three-dimensional object from a solidifiable by a sequential discharge of drops onto an object carrier for the object to be produced, the device including discharge unit with an outlet orifice discharges drops along an axis (s) in a direction to the object carrier, and control means configured to control the motion of the object carrier and the object on the one hand and the outlet orifice on the other hand relative to each other in space, where due to the fact that means are provided for a mutual alignment of the object carrier or the object on the one hand and the outlet orifice on the other hand and that can be controlled by control means, with the axis (s) in a mutually aligned state intersecting a surface of the object carrier or the already produced object, such that a method and a device are provided for the production of a three-dimensional object with geometric overhangs and/or undercuts using solidifiable materials.

### CROSS REFERENCE TO RELATED APPLICATIONS

The present application is related to and claims the priority of German Patent Application No. 10 2011 106 614.8, filed on 16 Jun. 2011, the entire content of which is herein incorporated by reference, and this application further is a continuation in part application of International Patent Application No. PCT/EP 2012/002513, the entire content of which is herein likewise incorporated by reference.

### TECHNICAL FIELD OF THE INVENTION

The invention relates to a device and a method for the production of a three-dimensional object made of solidifiable material.

### BACKGROUND

For the plastic parts manufacture, it is known that parts in large lot sizes or series are produced by way of injection molding or extrusion using injection molds. The advantage of plastic injection molding lies in particular in the ultra-precise manufacture of complex parts geometries, whereby the functionality of the injection molding procedure optimally covers the requirements for a cost-effective and economical production of plastic parts.

At the same time, the need is constantly growing for plastic parts for a quantity of 1 and for small lot sizes, such as sample parts, which need to be available on very short notice and have properties that resemble those of injection molded parts. Manufacturing methods generally known as prototyping and rapid manufacturing are available for the manufacture of said types of parts. In the majority of cases, said types of parts are manufactured without tools, that is, without injection molds, based on the generation of the geometry using 3D data. Said geometries are produced in the most diverse of fashions by means of appropriate means, such as melting of powder coatings through heat supply, e.g. by means of a laser; generative systems, such as print processes in different connecting forms of the powder particles; or also by means of the so-called melt extrusion process.

A printing technique for the manufacture of three-dimensional objects in layers by way of drop by drop delivery of a liquid material has been disclosed in EP 2 199 082 A1. The object to be created is moved underneath a stationary print head, whereby the object and the print head are aligned with each other. The print head is preferably arranged above the object, such that a vertical discharge of the drops is likely. Layer by layer is cured and a profile is subsequently ground out and cured.

The drop by drop delivery of a ceramic dispersion for the manufacture of dental ceramics is disclosed in WO 2007/083372 A1. During the manufacture, the object is placed onto an arm with five axes, with which points in space can only be covered partly.

A device is disclosed in WO 2011/011818 A1, in which material is delivered onto an object carrier by means of several delivery units through a outlet orifice in the form of drops for the production of an object. According to FIGS. 1 and 16 of that application, the purpose of one delivery unit having the nozzle is to deliver the material itself, while the other delivers a substance which can later be removed again, in order to create overhangs. The solutions illustrated in the figures are in each case designed such that the gravitational force is acting in a negative Y-direction. The vertically erected disk can rotate around its center axis and likewise move in the direction of the Z-axis according to FIG. 1, meaning that it is three-dimensionally moveable. The delivery unit is likewise moveable in different directions, whereby a certain angle to the vertical axis of 75 to 180 degrees is specified as an example for the arrangement of the delivery unit with respect to FIG. 16. This does not allow the creation of overhangs at the object to be produced.

A device for the production of a three-dimensional object on a multi-axis work table, which is moveable in a controlled manner in the coordinate directions x, y and z, is disclosed in U.S. Pat. No. 7,168,935 B1. The material delivered there is compacted in a sintering process by means of a stationary electron beam gun.

A device is disclosed in EP 1 886 793 A1 in which a injection molding unit known from the injection molding technology is coupled onto a pressurizable material storage for the fluid phase of a material. To create an object on an object carrier in a construction space, said material is discharged through a outlet orifice in the form of drops. Due to the adhesive strengths of the material, a high pressure and high melting temperatures are required for the material, especially because the drop should have a size of 0.01 to 0.5 mm³. In contrast to methods involving the use of powders, the adhesive strengths result in adhesiveness of the drops. For that device, control means are already provided for the object carriers to perform movements in the x, y as well as z direction relative to the discharge unit. In the process, the distance between the discharge unit and the object carrier is selected such that the drops are able to form a free flying drop on their flight trajectory.

### BRIEF SUMMARY

Based on said prior art, the invention provides a method and a device for the production of a three-dimensional object with geometric overhangs or undercuts with the use of solidifiable materials without additional supporting structures.

In practice, it has been determined that it is regularly necessary to also create overhangs or undercuts for the manufacture of geometric parts such as rapid prototyping parts made of solidifiable materials, such as thermoplastic materials. When using liquid solidifiable materials, such as liquefied plastics or similar, this is generally also possible without a supporting structure. For this purpose, the object carrier to create the object and/or the already partly created object on the one hand and the outlet orifice on the other hand are aligned with each other such that supporting structures are not required, in contrast e.g. to previously disclosed powder bed methods. This means that a movement of the object and if necessary also of the discharge unit can take place during the generative, shaping assembly of the object in space, wherein the axis of the discharge unit, that is, the axis of the drop-transporting direction, intersects with the surface of the object carrier or the already created object. In the process, the axis of the discharge unit is aligned, along which e.g. the preferably discontinuous drops are generated or the solidifiable material is discharged, at e.g. nearly a right angle to a tangent on the surface of the object to be produced, but at least such that the axis intersects with the surface. Since the solidifiable material is applied onto the already built up geometry of the object and is combined with it and solidified on it, the existing geometry can be aligned to said direction by means of three-dimensional movements, whereby said direction is also positioned in the direction of the gravitational force, although this is not compulsory. What is essential is that the object carrier and/or the object is arranged on a multi-axis geometry and pivotably mounted above a rotary motor on a 45° incline. From a forming technology point of view, any undercuts can be manufactured in this fashion.

It is principally possible to pivot the discharge unit and thus to realize other embodiments in combination with the movement of the discharge unit on the one hand and the movement of the object to be produced on the other hand, such as better shaping of corners.

The previously disclosed coordinate table is therefore preferably replaced with a multi-axis geometry, such as a compact 6-axis robot, such that in addition to the Cartesian coordinate system of one base, the other commutating coordinate system e.g. of the object arranged thereon is optimized for the control.

### BRIEF DESCRIPTION OF THE FIGURES

The invention is explained in more detail below based on exemplary embodiments illustrated in the Figures. In the figures:

FIG. 1 shows a three-dimensional view of a device having a discharge unit and an object carrier arranged on a multi-axis geometry,

FIG. 2, 3 shows the device according to FIG. 1 pivoted into different positions to create overhangs of an object to be manufactured,

FIG. 4 shows a representation according to FIG. 3 in an additional embodiment of the invention,

FIG. 5 shows an illustration according to FIG. 3 with the discharge unit slanted,

FIGS. 6a to 6d shows a schematic sequence chart of the assembly of an object

FIGS. 7 to 9 shows different positions of an alternative multi-axis geometry for moving the object carrier.

### DETAILED DESCRIPTION

The invention is now explained in more detail with reference to the attached drawings used as examples. However, the exemplary embodiments are only considered to be examples, which should not restrict the inventive concept to a specific arrangement. Before the invention is described in detail, it should be pointed out that it is not restricted to the respective components of the device as well as the respective methodical steps, because said components and methods can vary. The terms used herein exclusively serve the purpose of describing special embodiments and are not used in a restrictive manner. In addition, if the singular or indefinite articles are used in the description or in the claims, this likewise relates to the plural of said elements, unless the general context clearly suggests something to the contrary.

The figures show a device for the production of a three-dimensional object 50 made of solidifiable material, which is preferably in one embodiment of the invention either provided in a fluid phase in the starting status or can be liquefied. In this case, the production involves the sequential discharge of drops through a discharge unit 12. The discharge unit 12 is only illustrated schematically. Its design is generally known from the disclosure in EP 1 886 793 A1 or DE 10 2009 030 099 A1 and is herewith incorporated by reference to said patent documents. Said patent documents illustrate in detail the assembly of a three-dimensional object 50 by way of the sequential discharge of drops 70 from the clockable discharge unit 12. The object 50 is created layer by layer on the object carrier 13 by the drops 70 in this fashion. The discharge unit 12 is connected with a material storage, which is supplied with pressurized processed material from a processing unit by means of a pressure generation unit. The drops are generated by way of the clockable outlet orifice 12 and transported into a construction space in which the object 50 is assembled on the object carrier 13, 13′. The discharge unit 12 is preferably part of a plasticizing unit generally known in the injection molding technique, which at the same time also comprises the pressurizable material storage used to feed the fluid phase into the material storage. The pressure exerted onto the fluid phase in the material storage in direct coupling generates the drop 70.

In a further embodiment of the invention, the solidifiable material is discharged by any means. No drops therefore need to be generated. Moreover, the solidifiable material can be discharged in any direction.

In both cases, means are provided to align the object carrier 13, 13′ 13″ or the object 50, which is at least already partly produced, on the one hand, and the outlet orifice 12b on the other hand. Said means for alignment are controllable by means of controlling means 80 such that the axis s intersects in an aligned status a surface of the object carrier 13, 13′ 13″ or of the object 50 that has at least already partly been produced. The object carrier 13, 13′, 13″ or the object 50 is arranged on a multi-axis geometry and pivotably mounted above a rotary motor 231 at a 45° incline 240. With said arrangement, the solidifiable material can be passed to any undercuts such that the object can be assembled without any supporting material.

As it is essential for the use of the device as well as for the method, the property of the material is also addressed here. The solidifiable material is a plasticized material such as silicone or a plasticizable material such as plastic or powdery materials. The solidifiable material can be provided either in a fluid phase in the starting status or it can be liquefied, but this is not compulsory. Moreover, the material can be a reversibly thermally meltable and hence recyclable material. Any other materials can be used, as long as said materials are plasticizable by means of the device and above all things can be discharged through the at least one discharge unit 12.

In the fluid phase, the solidifiable material comprises a so-called laminar frontal flow. Among other things, the accumulation of molten material on the wall is incorporated into the frontal flow. This becomes most apparent in view of the knowledge about the injection molding technique. When the mold of a simple, rectangular channel is filled, the molten material is injected through a so-called gate point and starts expanding from this point in a circular shape with closed flow fronts until it fills the entire width of the cavity. Sometime thereafter, the area between the inlet and the flow front can be considered almost fully formed. A special flow situation, the “frontal flow”, is present at the flow front itself, because the flow lines in this area resemble a spring when viewed with respect to a co-moving coordinate system. The molten material flows between two quickly solidifying layers of mass positioned close to the cavity surfaces, whereby it approaches the flow front at greater speeds in the middle of the cavity. Shortly before the molten material reaches the flow front, its speed component is reduced in the flow direction; it flows diagonally to the wall until it comes to rest against the wall.

The following explanations predominantly relate to an embodiment in which the solidifiable material is discharged in the form of drops, because special precautions are required in that case. On the one hand, the laminar frontal flow is an advantage for the creation of drops 70, which—in one embodiment here—is ‘directed’ e.g. at a construction space because of its laminar formation, while on the other hand precisely here it causes problems, particularly in connection with small drops, which make difficult the implementation using devices and materials known from the injection molding technique. Because of the wall adhesion, the formation of masses of drops with desired small volumes, preferably in the range of smaller or equal to 1 mm³ and a desired flying speed is difficult, while an adequately high viscosity of the material is important on the other hand, especially for the formation of a suitable drop shape.

This is what distinguishes the used materials from previously disclosed waxes. Due to their viscosity, waxes can be discharged by way of the regular thermal pressure or inkjet method, that is, by way of purely kinematic, pressure-less acceleration without pressure difference of the molten drop. The materials used herein already differ hereof in that their viscosity number is higher by one to several of powers of ten. For instance, the dynamic viscosity number of the solidifiable material is between 100 and 10,000 [Pa s], whereby the solidifiable material is preferably a plastic common in the injection molding technique or a resin. This requires the processing from a pressurizable material storage, because pressures exceeding 10 to 100 MPa (100 to 1000 bar) are easily required, particularly if small discharge orifices are used to achieve small drop volumes.

The desired volume of the drop 70 is preferably in the range of 0.01 to 0.5 mm³, preferably in the range of 0.05 to 0.3 mm³ and particularly preferably in the range of about 0.1 mm³. The diameter of the outlet orifice 12b is in particular smaller or equal to 1 mm, preferably about 0.1 mm. With a definitely common injection speed of 100 [cm/s], which transports the mass through a so-called gate point with a diameter of 0.1 [mm], the volume flow divided by the surface area results in a value of 10,000 [m/s]. With respect to the fluid phase, this results in a laminar frontal flow with flow speeds of up to 10,000 m/s.

With its discharge unit 12, the device discharges ultra-viscous fluid materials, such as molten plastics, in tiniest quantities to the point of several micrograms from a material storage, pressurized with high pressure and possibly exposed to high temperatures. The tiniest quantities/drops 70 of the material are discharged in discrete single portions, whereby their size can be influenced by the device. The kinetic energy of the discharged portions is so high that they are able to overcome the adhesive strengths and lift off of the device and form drops 70 to assemble the object 50 on the object carrier 13.

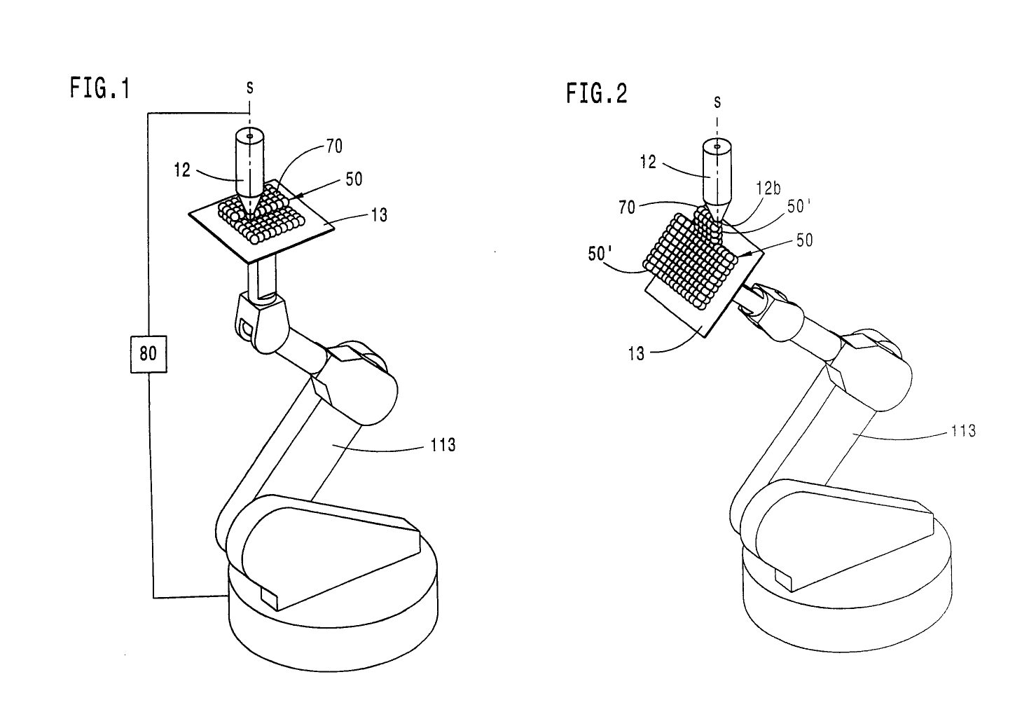

Under these conditions, the adhesive strengths of the material make it possible to form any outlines by means of a suitable arrangement of the discharge unit 12 on the one hand and the object carrier 13, 13′, 13″ and object 50 on the other hand. Control means 80 according to FIG. 1 can be provided for this purpose, which are suitable to control the movement of the object carrier 13, 13′, 13″ and/or the object 50 on the one hand and the outlet orifice 12b on the other hand. The movement of said elements can then take place relative to each other in space. If said elements are pivotably mounted in the device in said manner, the object carrier 13, 13′, 13″ or the object 50 and the axis s of the discharge unit 12 can be aligned with each other in any direction. According to a top view of the object carrier 13, the finished object 50 comprises overhangs 50′. They are created in that the drops can be formed on the object carrier 13 and/or on the object 50 as undercuts and overhangs 50′.

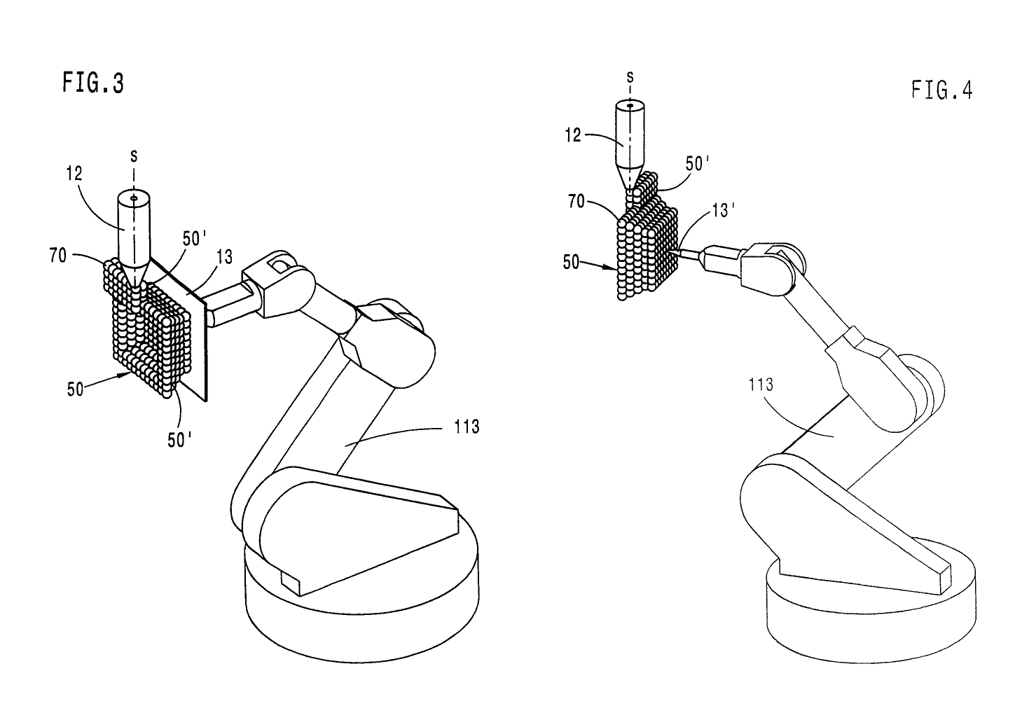

FIG. 1 to 4 illustrate that the discharge unit 12 is basically arranged vertically erected, while the object carrier 13 moves relative to it, irrespective of whether it is designed as a carrier plate as in FIG. 1 to 3 or as starting point as object carrier 13′ in FIG. 4. It is essential that means are formed with suitable drive units for the object carrier 13, 13′, 13″ and for the discharge unit 12 supporting the outlet orifice 12b for aligning the object carrier 13, 13′, 13″ and/or the object 50 on the one hand and the outlet orifice 12b on the other hand. However, normally and in a preferred exemplary embodiment, the outlet orifice 12b remains vertically erect and stationary, while the object carrier 13, 13′, 13″ is moved analogously.

The aligning means are controllable with control means 80. In the process, the axis s of the discharge unit, that is, the transport direction of the drops is aligned relative to the object carrier and/or the object in aligned status, such that it intersects a surface of the object carrier 13, 13′, 13″ or the already created object 50. This preferably results in an arrangement of the axis s, in which it is arranged on said surface almost at a right angle to a tangential area, i.e. mathematically normal to said surface. Said direction of the axis is preferably parallel to the direction of the gravitational force.

A comparison between FIGS. 1 and 2 shows clearly that e.g. the discharge unit 12 may be arranged vertically, i.e. the object 50 is moved underneath the discharge unit, preferably in reference to the discharge unit 12. The object 50 is located on the object carrier 13, which in turn is arranged on a 3D-actuator 113, as also known per se for robots. According to FIGS. 1 and 2 the object carrier 13 and/or the object 50 are arranged on a multi-axis geometry, preferably on a 6-axis robot. Actually a Cartesian coordinate table can be replaced by a spatial 6-axis system.

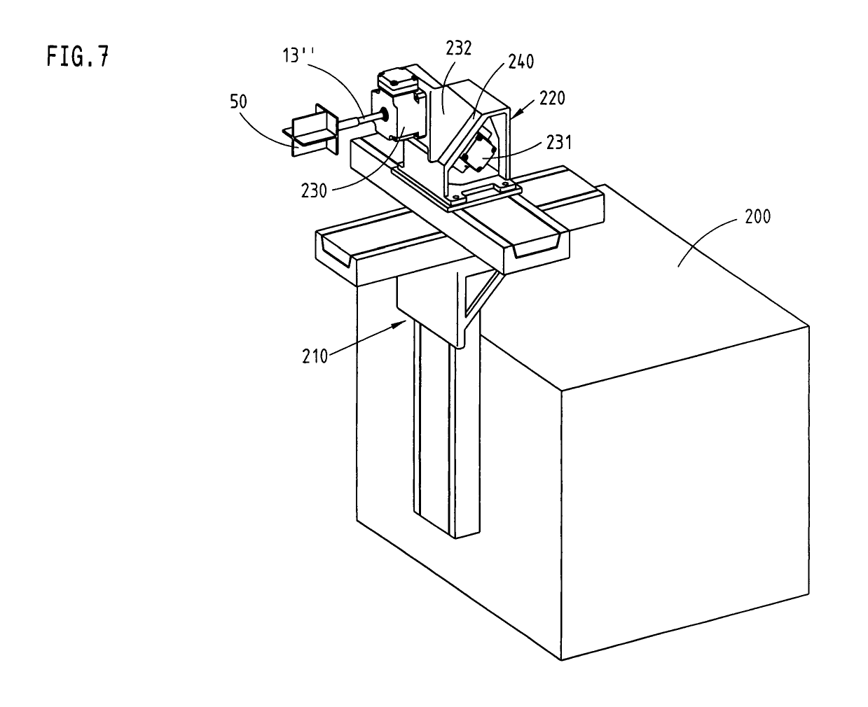

FIGS. 7, 8, and 9 show an alternative multi-axis geometry for the object carrier 13″ in three different positions. A coordinate table 210 is arranged on a frame 200, allowing a motion of a rotary table carrying an object carrier 13″ in three directions of coordinates. The drives for the motion of the sled of the coordinate table along the three directions of coordinates have been omitted to simplify the illustration. An angle table 232 is also supported at the rotary table 220 at a preferably 45° incline 240, also showing a preferably 45° incline and rotatable by a rotary motor 231. An object carrier 13″ is supported at the angle table 232, rotatable by a rotary motor 230. By combining the motions made possible by the rotary motors 230, 231, different positions of the object carrier 13″ can be approached in order to generate overhangs without a support structure.

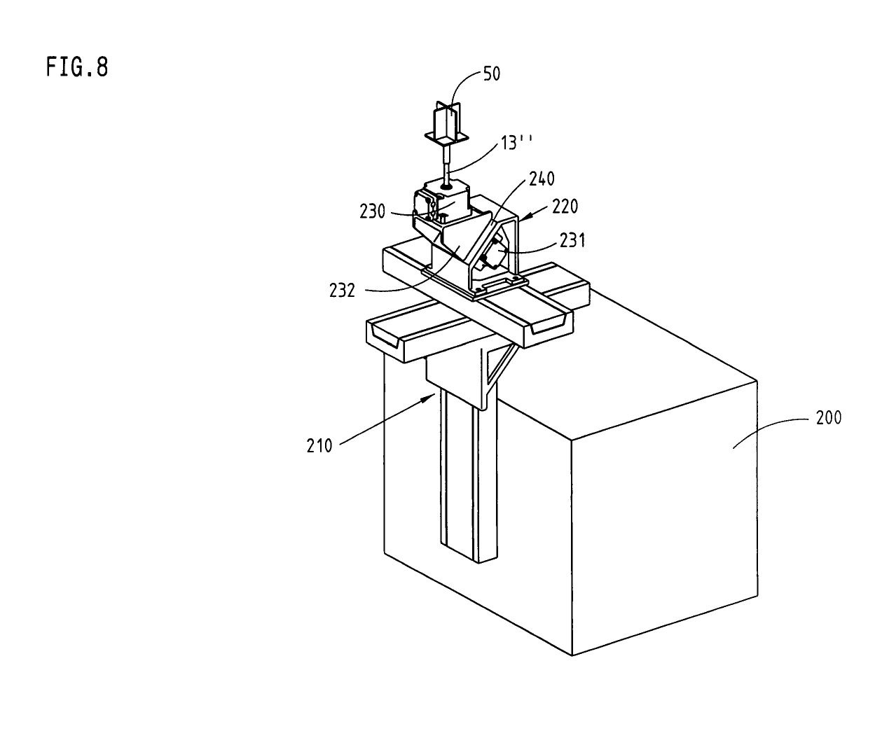

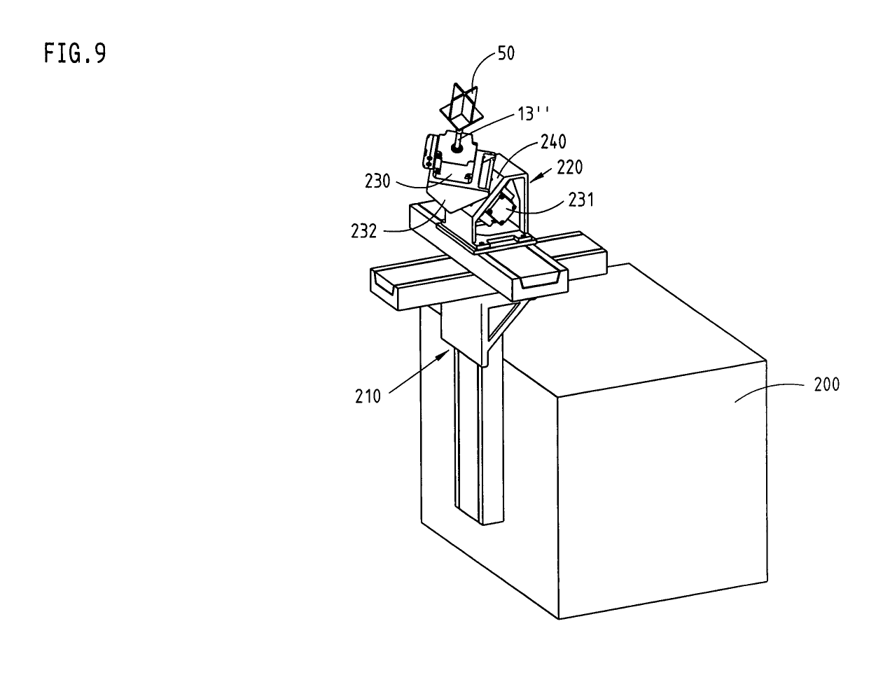

The object 50 can directly rotate by means of the rotary motor 230 and the object carrier 13″, which may be the central axis, e.g., for the production of a symmetric hollow body. By the rotary motor 231, the object 50 is pivoted with the object carrier 13″ over the incline 240, e.g. out of the horizontal position according to FIG. 7 into the vertical position according to FIG. 8. In order to allow realizing different angles, any arbitrary intermediate position is possible, as shown in FIG. 9.

This way, by expansion of the coordinate table 210 by the rotary table with two drive units and the capacity for rotation at an angle of e.g., 45°, an almost unlimited three-dimensional object 50 can be produced with overhangs requiring no support structure.

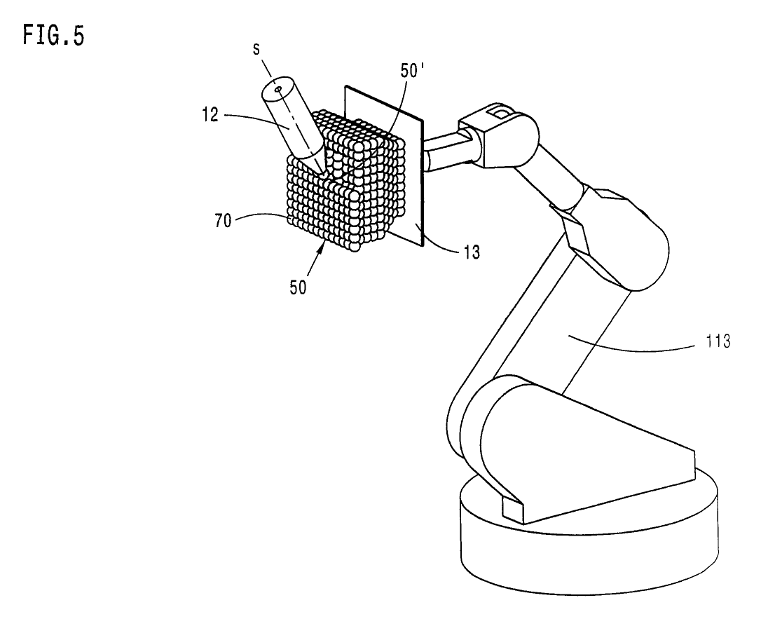

Potentially given overhangs 50′ of the object 50 can be formed according to FIGS. 2 to 4 by an alignment of the discharge unit and the object carrier 13, 13′ such that integrally forming occurs at the surfaces of the object carrier or the object. However, according to FIG. 5, they may also be formed by a limited pivoting and an appropriate alignment of the discharge unit 12. In general, a combination of these two alternatives is possible, such as. both the object 50 or the object carrier 13 as well as the discharge unit 12 are pivoted.

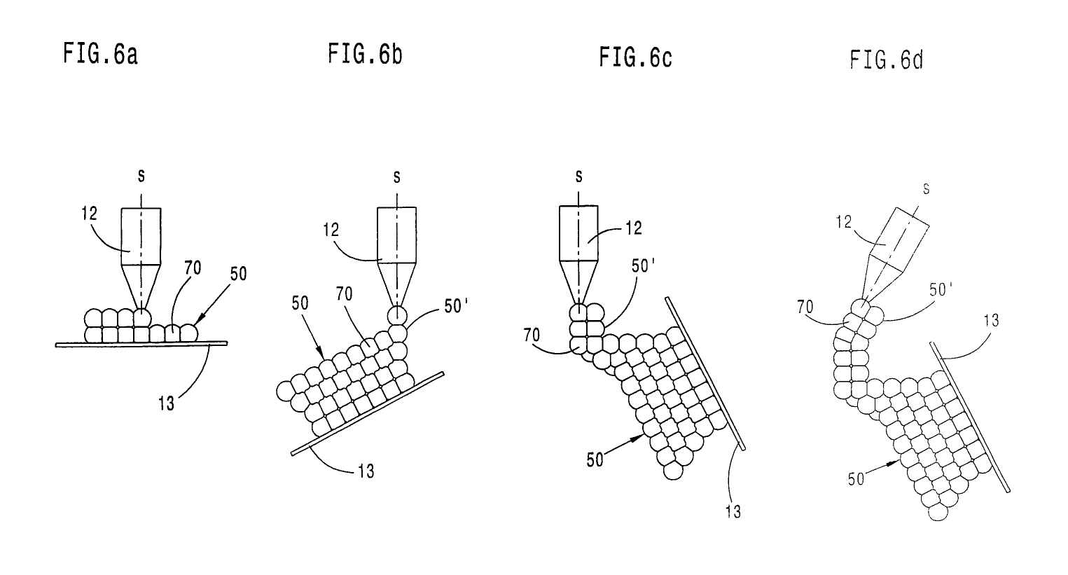

According to the method, the device operates as follows. First, the solidifiable material is provided respectively plasticized so that it is present in a fluid phase, in which it can be inserted into the clockable discharge unit 12. From the outlet opening 12b of the discharge unit 12 the solidifiable material is extruded e.g., in the form of drops 70 or in another suitable fashion, e.g., as a strand along the axis s in the direction towards the object carrier 13 in order to produce the three-dimensional object 50 (FIG. 6a). The object carrier 13 and/or the object 50 on the one hand and the outlet orifice 12b on the other hand are then spatially moved in reference to each other and mutually aligned. These elements are supported in a mobile and position controlled fashion and brought into their position by the control means 80. Then a mutual aligning process of the object carrier 13, 13′ and/or the object 50 and the axis s occurs, with preferably the next material delivery being added normally, i.e. at a right angle in reference to a tangent on the already generated or existing surface (FIG. 6b). However, other discharge directions are also possible. This normal arrangement towards the area is approximately equivalent to the direction of construction of the object. FIGS. 6a through 6d illustrate this fact clearly using the production of a cup. In particular FIGS. 6c and 6d show how the discharge unit 12 and the object 50 can be aligned relatively to each other such that in this case the next drop will contact the already produced object 50 as effectively as possible in order to hereby form the overhangs 50′. This way the solidifiable material can be added to the object 50 as an overhang 50′.

When the solidifiable material is not discharged in the form of drops, again an object carrier 13, 13′, 13″ is provided for the object 50 to be produced. The control means 80 serve to control the motion of the object carrier 13, 13′, 13″ or the object 50 on the one hand and the outlet orifice 12b on the other hand relatively to each other in the space. The object carrier 13, 13′, 13″ or the object 50 on the one hand and the outlet orifice 12b on the other hand are aligned to each other, whereby the axis s in the mutually aligned status intersects a surface of the object carrier 13, 13′, 13″ or the already produced object 50. The object carrier 13, 13″ or the object 50 are arranged on a multi-axis geometry and supported at a 45°-incline 240, rotatable by a rotary motor 231.

Here, the solidifiable material is preferably provided in an arbitrary fashion, i.e., it is only relevant that it can be discharged by the outlet orifice.

It is self-evident that this description may be subjected to various modifications, alterations, and adjustments, which are within the range of equivalent alternatives to the attached claims.

1. A device for production of a three-dimensional object from a solidifiable material, which is either present in an original state in a fluid phase or can be liquefied, by a sequential discharge of drops, the device comprising:
an object carrier for the object, which is to be produced,
a discharge unit with an outlet orifice for discharging the solidifiable material in the form of drops along an axis in a direction towards the object carrier in order to construct an object,
control means for controlling a motion of the object carrier or the object on the one hand and the outlet orifice on the other hand relative to each other in the space,
means for mutually aligning of the object carrier or the object, which is already at least partially produced, on the one hand, and the outlet orifice on the other hand in a mutually aligned state, which means for mutually aligning are controlled by the control means, with the axis in the mutually aligned state intersecting a surface of the object carrier or the object, which is already at least partially constructed,
wherein the axis in the mutually aligned state is arranged at a right angle in reference to a tangent to the surface and in the direction of gravity, and
wherein the object carrier or the object, which is already at least partially constructed, is arranged on a multi-axis geometry and supported at a 45°-incline, rotatable by a rotary motor.

2. A device according to claim 1, wherein in the mutually aligned state the axis is aligned to integrally form overhangs at the object to be produced on the object carrier.

3. A method for production of a three-dimensional object comprising a solidifiable material, which is either present as a fluid in an original state or can be liquefied, by a sequential discharge of drops, the method comprising:
providing the solidifiable material in a fluid phase or plasticizing the solidifiable material into the fluid phase,
inserting the fluid phase into a clockable discharge unit,
discharging the drops from an outlet orifice of a discharge unit along an axis in a direction towards an object carrier for the three-dimensional object to be produced, with the object carrier or the object, which is already at least partially produced, on the one hand, and the outlet orifice on the other hand, being movable in space relative to each other,
a position-controlled, mutual alignment of the object carrier or the object, which is already at least partially produced, on the one hand and the outlet orifice on the other hand, wherein the axis in a mutually aligned state intersecting a surface of the object carrier or of the object, which is already at least partially produced,
wherein the axis in the mutually aligned state is arranged approximately at a right angle in reference to a tangent to the surface and the discharge of the drops occurs in a direction of gravity, and
wherein the object carrier or the object, which is already at least partially produced, is arranged on a multi-axis geometry and supported at a 45°-incline, rotatable by a rotary motor.

4. A method according to claim 3, wherein the axis is aligned such that the drops are added to the object carrier or the object as overhangs.

5. A device for producing a three-dimensional object comprising a solidifiable material, the device comprising:
an object carrier for the object to be produced, a discharge unit with an outlet orifice for discharging the solidifiable material along an axis in a direction towards the object carrier for constructing the object,
control means for controlling the motion in space of at least one element comprising the object carrier or the object on the one hand and the outlet orifice on the other hand,
means for a mutual alignment of the object carrier or the object on the one hand and the outlet orifice on the other hand, which means for a mutual alignment are controlled for a mutual alignment by the control means, with the axis in a mutually aligned state intersecting a surface of the object carrier or the already produced object,
wherein the object carrier or the object is arranged on a multi-axis geometry and supported at a 45°-incline, rotatable by a rotary motor.

6. A device according to claim 1, wherein in the mutually aligned state the axis is aligned to form overhangs at the object to be produced at the object carrier.

7. A method for the production of a three-dimensional object comprising a solidifiable material, the method comprising:
providing the solidifiable material in a discharge unit,
discharging the solidifiable material from an outlet orifice of the discharge unit along an axis in a direction towards the object carrier for an object to be produced, wherein the object carrier or the object to be produced on the one hand and the outlet orifice on the other hand are movable in space relative to each other,
a position-controlled, mutual alignment of the object carrier or the object on the one hand and the outlet orifice on the other hand, wherein in a mutually aligned state the axis intersecting a surface of the object carrier or of an already at least partially produced object,
wherein the object carrier or the object is arranged on a multi-axis geometry and supported at a 45°-incline, rotatable by a rotary motor.

8. A method according to claim 3, wherein the axis is aligned such that the solidifiable material is added at the object carrier or at the object as an overhang.
